(19) United States
(12) Patent Application Publication
(10) Pub. No.: US 2021/0114293 A1
(43) Pub. Date: Apr. 22, 2021

(54) 4D PRINTING DEVICE

(71) Applicant: FOUNDATION OF SOONGSIL UNIVERSITY INDUSTRY COOPERATION, Seoul (KR)

(72) Inventors: Joo Yong KIM, Seoul (KR); Min Ki CHOI, Incheon (KR); Thai Son LY, Seoul (KR)

(21) Appl. No.: 16/608,612

(22) PCT Filed: Apr. 17, 2018
(86) PCT No.: PCT/KR2018/004439

§ 371 Date: Oct. 25, 2019

(30) Foreign Application Priority Data
Apr. 27, 2017 (KR) 10-2017-0054519
May 23, 2017 (KR) 10-2017-0063605

(51) Int. Cl. B29C 64/209; B29C 64/112; B29C 64/118; B29C 64/393; B29C 64/291; B33Y 30/00; B33Y 50/02; B33Y 70/00

(52) U.S. Cl. CPC B29C 64/209; B29C 64/112; B29C 64/118; B29C 64/393; B29K 2995/0012; B33Y 30/00; B33Y 50/02; B33Y 70/00; B29C 64/291

(57) ABSTRACT

A 4D printing device is disclosed. The disclosed 4D printing device comprises: a first nozzle for outputting a first material on the basis of a 3D printing type A; and a second nozzle for outputting a second material on the basis of a 3D printing type B.

### BACKGROUND

### 1. Technical Field

Embodiments of the present invention relate to a 4D printing device that is capable of manufacturing a high-performance smart material through a single process and using the material to output a 3-dimensional object.

### 2. Description of the Related Art

4D printing refers to a technology for manufacturing a 3-dimensional printed object through a 3D printing technique by using a smart material that changes shape by itself and forms a new shape when a pre-designed time condition or an arbitrary threshold environmental condition (e.g. in regard to temperature, humidity, vibration, electricity, etc.) is satisfied.

FIG. 1 illustrates an example of a printed object provided using 4D printing according to the related art. Referring to FIG. 1, the 4D printed object changes shape with time under a threshold environmental condition.

4D printing was introduced by Skylar Tibbits from the Self-Assembly Lab of the Massachusetts Institute of Technology at the 2013 TED (technology entertainment design) conference. 4D printing can be utilized in various fields, such as automobiles, smart clothing, aviation, military defense, medicine, etc.

In 4D printing, a printed object may be fabricated with a 3D printing device that employs FDM (fused deposition modeling), DLP (digital light processing), SLS (selective laser sintering), the polyjet method, etc.

Here, when a 3D printing device of the FDM type is used to fabricate an object with 4D printing, the low printing resolution resulting from diameters of the nozzles may make it difficult to output an object that requires a detailed portrayal and thus may need post-processing. The DLP type may provide a higher printing resolution compared to the FDM type but can only use photocurable materials and entails a high price for the equipment. Also, the SUS type may provide a very high printing resolution, but the types of materials that can be used are relatively few, while the price and maintenance costs for the equipment are high.

### SUMMARY OF THE INVENTION

To resolve the problems of the related art described above, the present invention proposes a 4D printing device that manufacture a high-performance smart material through a single process and use the material to output a 3-dimensional object.

Other objectives of the present invention can be derived by the skilled person from the embodiments set forth below.

To achieve the objectives above, a preferred embodiment of the present invention provides a 4D printing device that includes a first nozzle configured to output a first material based on a 3D printing method A; and a second nozzle configured to output a second material based on a 3D printing method B.

The glass transition temperature of the first material can be different from the glass transition temperature of the second material.

The 3D printing method A can be a polyjet method, and the 3D printing method B can be a FDM (fused deposition modeling) method.

The first material can be a photocurable material containing a conductive paste, and the second material can be a filament molded from a mixture of a shape-memory polymer (SMP), a functionalized carbon nanotube (CNT), and a superabsorbent polymer (SAP).

One of the first material and the second material can form a matrix, and the remaining one of the first material and the second material can form a filler.

The 4D printing device can further include: a first storage unit connected to the first nozzle and configured to store the first material; a UV lamp located adjacent to the first nozzle and configured to cure the first material outputted from the first nozzle; a second storage unit connected to the second nozzle and configured to store the second material; a control unit configured to control the supply speed of the first material to the first nozzle, the supply speed of the second material to the second nozzle, the operation of the first nozzle, the operation of the second nozzle, and the operation of the UV lamp; and a printing plate configured to receive the first material outputted from the first nozzle and the second material outputted from the second nozzle.

Another embodiment of the present invention provides a 4D printing device that includes: a multiple number of nozzles configured to output a of materials, respectively; and a control unit configured to control the operations of the multiple nozzles, where the multiple number of nozzles output the multiple number of materials with different 3D printing methods, and the multiple materials have different glass transition temperatures.

A 4D printing device based on the present invention is capable of manufacturing a high-performance smart material through a single process and using the material to output a 3-dimensional object.

It should be appreciated that the effects of the present invention are not limited to the effect described above but rather encompass all effects that can be derived from the composition of the present invention as disclosed in the detailed description or the scope of claims.

### BRIEF DESCRIPTION OF THE DRAWINGS

FIG. 1 illustrates an example of a printed object provided using 4D printing according to the related art.

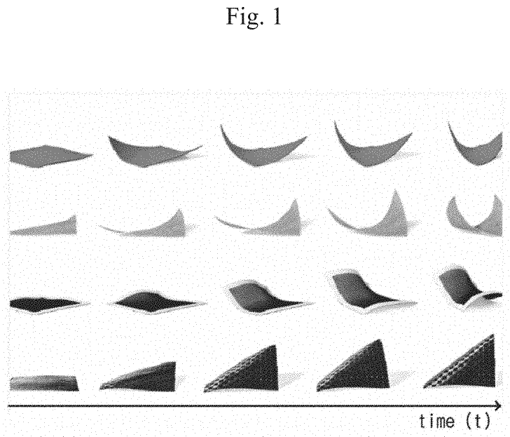

FIG. 2 schematically illustrates the composition of a 4D printing device according to an embodiment of the present invention.

FIG. 3 illustrates a printed object (a smart complex material) formed by combining a first material from a first nozzle and a second material from a second nozzle according to an embodiment of the present invention.

### DETAILED DESCRIPTION OF THE INVENTION

In the present specification, an expression used in the singular encompasses the expression of the plural, unless it has a clearly different meaning in the context. In the present specification, terms such as “composed of” or “including,” etc., are not to be interpreted as meaning that the several elements or steps mentioned thereafter must necessarily be included. Rather, such disclosure should be interpreted to mean that some of the elements or steps may not be included, while other additional elements or steps may further be included. A term such as “unit,” “module,” etc., disclosed in the specification represents a unit by which at least one function or operation is processed, where this can he implemented as hardware or software or a combination of hardware and software.

Various embodiments of the present invention are described below in snore detail with reference to the accompanying drawings.

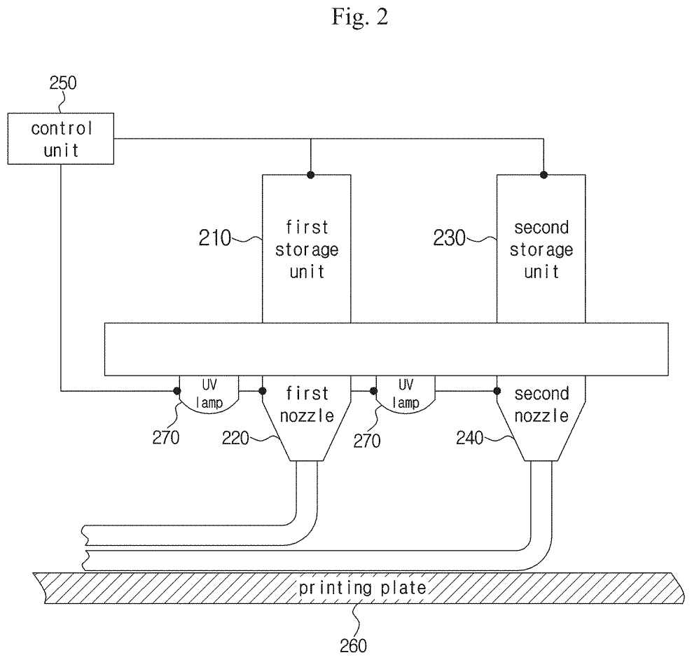

FIG. 2 schematically illustrates the composition of a 4D printing device according to an embodiment of the present invention.

Referring to FIG. 2, a 4D printing device 200 according to an embodiment of the present invention can include a first storage unit 210, a first nozzle 220, a second storage unit 230, a second nozzle 240, a control unit 250, and a printing plate 260. The function of each component is described below in further detail.

The first storage unit 210 may store a first material. Also, the first nozzle 220 may be connected with the first storage unit 210 and may output the first material that is stored in the first storage unit 210. That is, the first storage unit 210 and the first nozzle 220 can form a 3D printing device A that outputs a first material according to a 3D printing method A.

According to an embodiment of the present invention, the 3D printing method A can be a polyjet method. In this case, the 4D printing device 200 can further include a UV lamp 270 for curing the first material outputted through the first nozzle 220.

The polyjet method is a method of photocuring layers that involves irradiating rays to harden a substance and thus form a 3-dimensional model, and a special plastic resin which reacts to the UV lamp 270 to change from a liquid to a solid state is utilized to stack layers. As such, at least one UV lamp 270 can be positioned adjacent to the first nozzle 220.

According to an embodiment of the present invention, in cases where the 3D printing method. A is a polyjet method, the first material can be a photocurable material containing a conductive paste.

The second storage unit 230 may store a second material, and the second nozzle 240 may connect to the second storage unit 230 and may output the second material stored in the second storage unit 230. That is, the second storage unit 230 and the second nozzle 240 can form another 3D printing device that outputs a second material according to a 3D printing method B.

According to an embodiment of the present invention, the 3D printing method B can be a FDM (fused deposition modeling) method. In this case, the second storage unit 230 or the second nozzle 240 can include a heater for providing the fusion temperature of the second material.

That is, the FDM method uses a thin linear form of solid (a filament) and uses the principle of melting a fusible plastic with heat applied to the nozzle, molding the plastic, and then hardening the plastic back to a solid in air. As such, the second storage unit 230 or the second nozzle 240 may include a heater for applying the heat.

According to an embodiment of the present invention, in cases where the 3D printing method B is FDM, the second material can be a filament molded from a mixture of a shape-memory polymer (SMP), a functionalized carbon nanotube (CNT), and a superabsorbent polymer (SAP). In such cases, the shape-memory polymer (SMP) can cause a shape change depending on temperature, and the superabsorbent polymer (SAP) can cause a shape change depending on humidity.

According to an embodiment of the present invention, the glass transition temperature (Tg) of the first material and the glass transition temperature of the second material can be different. In particular, it may be preferable that there be a large difference between the glass transition temperature of the first material and the glass transition temperature of the second material. This will be described in more detail later on.

The control unit 250 may control the operations of the first storage unit 210, the first nozzle 220, the second storage unit 230, the second nozzle 240, and the UV lamp 270. That is, the control unit 250 may control the supply speed of the first material to the first nozzle 220 (i.e. operation of the first storage unit 210), the supply speed of the second material to the second nozzle 240 (i.e. operation of the second storage unit 230), the operation of the first nozzle 220, the operation of the second nozzle 240, and the operation of the UV lamp 270. Also, the printing plate 260 may receive the first material outputted through the first nozzle 220 and the second material outputted through the second nozzle 240, and the first material and second material thus received may form the final printed object.

For instance, in cases where the 3D printing method A adopted for the first storage unit 210 and first nozzle 220 is a polyjet method and the 3D printing method B adopted for the second storage unit 230 and second nozzle 240 is a FDM method, the conductive material included in the first material and the carbon nanotubes (CNT) included in the second material may generate heat, and when the temperature exceeds the threshold temperature for the shape-memory polymer (SMP), the printed object formed from the first material and second material may undergo a shape change

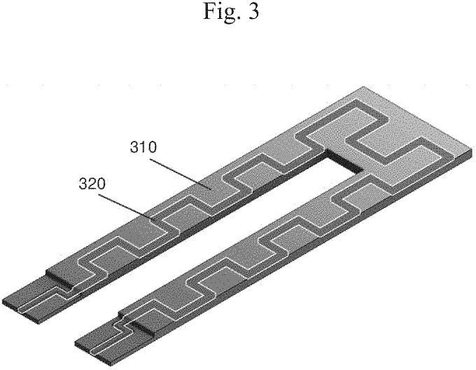

FIG. 3 illustrates a printed object (a smart complex material) formed by combining a first material from a first nozzle 220 and a second material from a second nozzle 240 according to an embodiment of the present invention. Here, any one of the first material and second material can form a matrix 310 for the smart complex material, and the remaining one of the first material and second material can form a filler 320 for the smart complex material.

Under the control of the control unit 250, the output of the first material by the first nozzle 220 and the output of the second material by the second nozzle 240 can be performed sequentially with the passage of time or can be performed simultaneously. In the example shown in FIG. 3, if the first material is to form the filler 320 and the second material is to form the matrix 310, then the second nozzle 240 can first output the second material, and the first nozzle 220 can output the first material afterwards. Also, if the first material is to form the matrix 310 and the second material is to form the filler 320, then the first nozzle 220 can first output the first material, and the second nozzle 240 can output the second material afterwards.

In short, the present invention relates to a 4D printing device 200 with which different materials can be outputted through two different 3D printing methods. In particular, it may be preferable that the glass transition temperature of the first material and the glass transition temperature of the second material have a large difference, as mentioned above. For example, it may be preferable that the glass transition temperature of the second material (e.g. DM8530) and the glass transition temperature of the first material (e.g. TangoBlack+) have a difference of 55° C. or higher. This is in order to increase the performance of the shape memory element made from the smart complex material formed by the first material and second material.

To be more specific, a conventional 4D printing device that uses only one 3D printing method uses one or more nozzles to output a smart material. Here, the glass transition temperatures of the materials used with the one 3D printing method are limited, and forming a smart material by using materials having similar glass transition temperatures has the drawback that the shape memory performance is not that great.

However, a 4D printing device 200 based on the present invention may use two different 3D printing methods with materials having a large difference in glass transition temperatures, with the two materials outputted through different nozzles in a single process to create a smart complex material. Therefore, the smart complex material, i.e. the printed object, outputted by a 4D printing device 200 based on the present invention provides the advantage of high shape memory performance.

According to another embodiment of the present invention, a 4D printing device based on the present invention can use three or more types of 3D printing methods.

That is, a 4D printing device according to another embodiment of the present invention can include three or more storage units that store three or more materials, respectively, and three or more nozzles that correspond to the three or more storage units and output the three or more materials, respectively.

The composition of such 4D printing device according to another embodiment of the present invention is similar to that of the 4D printing device 200 described above, and as such, further details are omitted here.

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

What is claimed is:

1. A 4D printing device comprising:
a first nozzle configured to output a first material based on a 3D printing method A; and
a second nozzle configured to output a second material based on a 3D printing method B.

2. The 4D printing device of claim 1, wherein a glass transition temperature of the first material is different from a glass transition temperature of the second material.

3. The 4D printing device of claim 1, wherein the 3D printing method A is a polyjet method, and
the 3D printing method B is a FDM (fused deposition modeling) method.

4. The 4D printing device of claim 3, wherein the first material is a photocurable material containing a conductive paste, and
the second material comprises a filament molded from a mixture of a shape-memory polymer (SMP), a functionalized carbon nanotube (CNT), and a superabsorbent polymer (SAP).

5. The 4D printing device of claim 1, wherein any one of the first material and the second material forms a matrix, and a remaining one of the first material and the second material forms a filler.

6. The 4D printing device of claim 1, further comprising:
a first storage unit connected to the first nozzle and configured to store the first material;
a UV lamp located adjacent to the first nozzle and configured to cure the first material outputted from the first nozzle;
a second storage unit connected to the second nozzle and configured to store the second material;
a control unit configured to control a supply speed of the first material to the first nozzle, a supply speed of the second material to the second nozzle, an operation of the first nozzle, an operation of the second nozzle, and an operation of the UV lamp; and
a printing plate configured to receive the first material outputted from the first nozzle and the second material outputted from the second nozzle.

7. A 4D printing device comprising:
a plurality of nozzles configured to output a plurality of materials, respectively; and
a control unit configured to control operations of the plurality of nozzles,
wherein the plurality of nozzles output the plurality of materials with different 3D printing methods, and
the plurality of materials have different glass transition temperatures.
